(19) United States
(12) Patent Application Publication
(10) Pub. No.: US 2016/0370255 A1
(43) Pub. Date: Dec. 22, 2016

(54) SYSTEM AND METHOD FOR DETECTING ENGINE EVENTS WITH AN ACOUSTIC SENSOR

(71) Applicant: GM GLOBAL TECHNOLOGY OPERATIONS LLC, Detroit, MI (US)

(72) Inventors: Akram R. Zahdeh, Rochester Hills, MI (US); Ian J. MacEwen, White Lake, MI (US)

(73) Assignee: GM GLOBAL TECHNOLOGY OPERATIONS LLC, Detroit, MI (US)

(21) Appl. No.: 15/134,858

(22) Filed: Apr. 21, 2016

Related U.S. Application Data
(60) Provisional application No. 62/180,426, filed on Jun. 16, 2015.

(51) Int. Cl. G01M 15/12

(52) U.S. Cl. CPC G01M 15/12

(57) ABSTRACT

A system for detecting engine events includes an engine assembly, and an acoustic emission sensor mounted on the engine assembly. A controller has a processor configured to execute stored instructions and is programmed to convert the signal into one or more frequency components, filter the signal with a band pass filter and determine a power value of each of the one or more frequency components within the range of frequencies of the band pass filter. The controller then compares the power value of each of the one or more frequency components to a reference value associated with acoustic emissions in the engine assembly during a baseline engine cycle. The controller adjusts at least one operating parameter of the engine assembly if the power value differs from the reference value by at least a predetermined amount. A corresponding method of controlling an engine assembly is disclosed.

### CROSS-REFERENCE TO RELATED APPLICATION

This application claims the benefit of U.S. Provisional Application No. 62/180,426 filed Jun. 16, 2015, which is hereby incorporated by reference in its entirety.

### TECHNICAL FIELD

The present teachings generally include a system for detecting engine events using an acoustic emission sensor, and a method.

### BACKGROUND

Acoustic emissions are elastic waves in solids that occur due to the release of accumulated elastic energy in the material upon an irreversible change in the material such as under mechanical loading. Acoustic emission sensors are typically piezoelectric sensors in which mechanical strain of a piezo element due to the elastic waves generates an electric signal.

### SUMMARY

A system for detecting engine events includes an engine assembly, and an acoustic emission sensor mounted on the engine assembly. The acoustic emission sensor is configured to provide a signal indicative of acoustic emissions in the engine assembly during an engine cycle. The system includes a controller operatively connected to the acoustic emission sensor to receive the signal. The controller has a processor configured to execute stored instructions, and is programmed to convert the signal into one or more frequency components. The controller is programmed to filter the signal with a band pass filter to eliminate any of the frequency components outside of a range of frequencies of the band pass filter. The controller is programmed to determine a power value of each of the one or more frequency components within the range of frequencies of the band pass filter. The frequency components and the power value may be determined according to Fourier analysis. For example, the power value may be a root mean square power. The power value of each of the one or more frequency components is then compared to a reference value associated with acoustic emissions in the engine assembly during a baseline engine cycle. The controller is programmed to adjust at least one operating parameter of the engine assembly if the power value differs from the reference value by at least a predetermined amount. In this manner, the acoustic emission sensor is used in conjunction with the controller to monitor and control operation of the engine assembly.

In one aspect, the system can focus on detection of the occurrence of a specific engine event as the controller is programmed to identify a portion of the signal correlated with a predetermined range of engine crank angles characteristic of an occurrence of the specific engine event. The controller may be programmed to determine whether any of the one or more frequency components of the portion of the signal are within a predetermined range of frequencies. The predetermined range of engine crank angles and the predetermined range of frequencies may be referred to as a window. The controller may be programmed to determine the power value only with respect to the one or more frequency components of the portion of the signal that are within the predetermined range of frequencies of the window. The portions of the signal that do not meet the crank angle and frequency window criteria of the window are not further analyzed, thus saving on processing time. Multiple different windows can be identified each of which is correlated with a different specific engine event of interest, and the controller may be programmed to focus only on the signal data correlated with these windows.

The acoustic emission sensor can be mounted on the engine assembly in any of a variety of different portions of the engine assembly, including locations outside of the cylinder bores which are relatively easy to access and are in less harsh environments. Acoustic emissions emanating from any portion on the engine assembly can be detected by a single acoustic emission sensor mounted on the engine assembly. As used herein, an emission sensor mounted in the engine assembly is considered to be mounted on the engine assembly.

The above features and advantages and other features and advantages of the present teachings are readily apparent from the following detailed description of the best modes for carrying out the present teachings when taken in connection with the accompanying drawings.

### BRIEF DESCRIPTION OF THE DRAWINGS

FIG. 1 is a schematic plan view of a portion of a vehicle including an engine assembly and a system for detecting engine events in accordance with one aspect of the present teachings.

FIG. 2 is a schematic perspective view of a portion of the engine assembly of FIG. 1.

FIG. 3 is a flow diagram of a method of detecting engine events.

FIG. 4 is a plot of frequency in kilohertz (kHz) versus engine crank angle in degrees for a signal of the acoustic emission sensor of FIG. 1 as collected over an engine cycle of the engine assembly of FIG. 1 with the value of the power spectral density in decibels (dB) per unit of frequency (Hz) of each frequency indicated by shading.

FIG. 5 is a scale of values of power spectral density (dB/kHz) indicated by shading.

FIG. 6 is a plot of frequency in kilohertz (kHz) versus power spectral density in decibels per unit of frequency (dB/Hz) for the signal indicated in FIG. 4 averaged over the engine cycle of FIG. 4.

FIG. 7 is a plot of power spectral density in decibels per unit of frequency (dB/Hz) versus engine crank angle in degrees for the signal of FIG. 4 over the engine cycle of FIG. 4.

FIG. 8 is a plot of pressure (bar) on the left vertical axis and heat release rate (Joules per crank angle) on the right axis vertical versus engine crank angle for a cylinder of the engine assembly of FIG. 1.

FIG. 9 is a plot of frequency in kilohertz (kHz) versus engine crank angle in degrees for the signal of the acoustic emission sensor of FIG. 1 as collected over an engine cycle of the engine assembly of FIG. 1 under different operating conditions, with the value of the power spectral density in decibels (dB) per unit of frequency (Hz) of each frequency indicated by shading.

FIG. 10 is a plot of power spectral density in decibels per unit of frequency (dB/Hz) versus engine crank angle in degrees for the signal of FIG. 8 over the engine cycle of FIG. 9.

FIG. 11 is a plot of pressure (bar) versus engine crank angle for a cylinder of the engine assembly of FIG. 1.

FIG. 12 is a plot of frequency in kilohertz (kHz) versus power spectral density in decibels per unit of frequency (dB/Hz) for the signal indicated in FIG. 9 averaged over the engine cycle of FIG. 9.

FIG. 13 is a grid of windows of ranges of frequencies and crank angles selected for discretization of the plot of FIG. 9.

FIG. 14 shows the grid of FIG. 13 overlaid on the plot of frequency in kilohertz (kHz) versus engine crank angle of FIG. 9.

### DETAILED DESCRIPTION

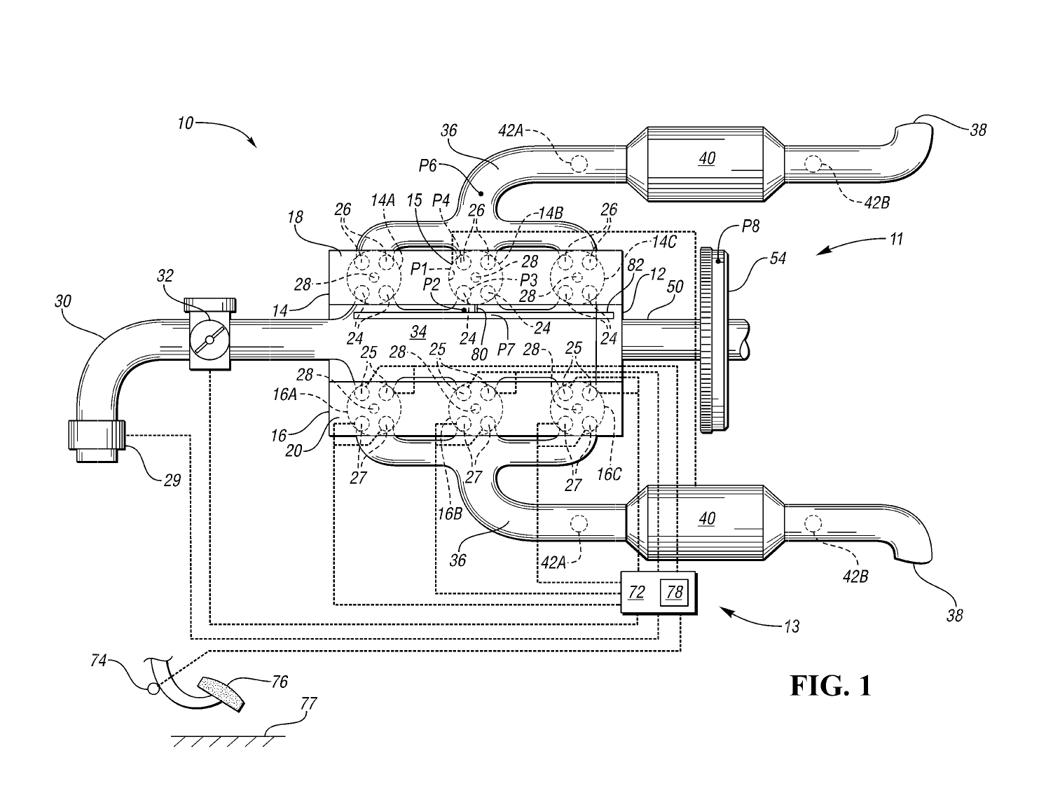

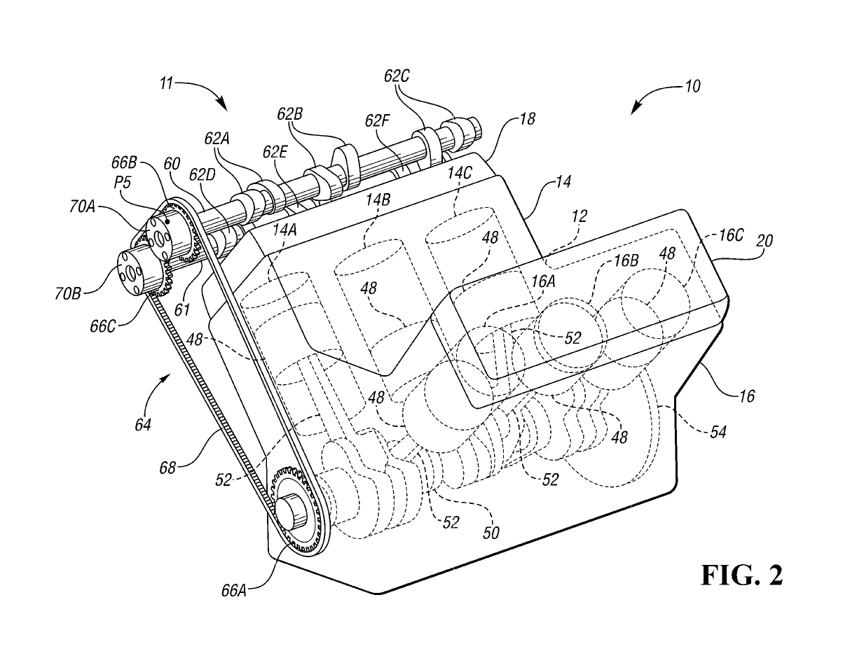

Referring to the drawings, wherein like reference numbers refer to like components, FIGS. 1 and 2 show a portion of a vehicle 10 with an engine assembly 11. The vehicle 10 includes a system 13 (shown in FIG. 1) that can be used to identify abnormalities in the operation of the engine assembly 11, and make adjustments to correct for the abnormalities. More specifically, the system 13 for detecting engine events includes the engine assembly 11 with an acoustic emission sensor 15 mounted on the engine assembly 11 in any of various locations as described herein. An acoustic emission sensor 15 may be a piezoelectric mechanism that provides an electrical sensor signal, typically a level or voltage, that is representative of the level of acoustic emissions within the detection range of the sensor. Acoustic emissions are a release of energy as indicated by elastic waves (i.e., movement) in a material due to a mechanical strain in the material. Abnormal engine events can produce acoustic emissions different than acoustic emissions typically produced under a normal (i.e., baseline) engine cycle.

The engine assembly 11 has a cylinder block 12 configured with a first bank 14 of cylinders 14A, 14B, 14C and a second bank 16 of cylinders 16A, 16B, 16C. A first cylinder head 18 is supported by the cylinder block 12 over the first bank 14 of cylinders 14A, 14B, 14C. A second cylinder head 20 is supported by the cylinder block 12 over the second bank 16 of cylinders 16A, 16B, 16C. The cylinder head 18 supports a first set of valves, including a pair of inlet valves 24 and a pair of outlet valves 26 positioned above each of the cylinders 14A, 14B, 14C. The outlet valves may also be referred to herein as exhaust valves. In other embodiments, there may be only one inlet valve and one outlet valve for each cylinder 14A, 14B, 14C, 16A, 16B, 16C. A spark plug 28 is also positioned above each of the cylinders 14A, 14B, 14C. The cylinder head 20 supports a second set of valves, including a pair of inlet valves 25 and a pair of outlet valves 27 above each of the cylinders 16A, 16B, 16C. The outlet valves 26, 27 are also referred to herein as exhaust valves. A spark plug 28 is also positioned above each of the cylinders 16A, 16B, 16C.

Air is directed from an air inlet passage 30 through a single electronic throttle 32 to a common air intake manifold 34 that provides inlet air to each of the cylinders 14A, 14B, 14C, 16A, 16B, 16C as the inlet valves 24, 25 are successively selectively opened in the manner described herein. A mass air flow (MAF) sensor 29 provides parameters indicative of inlet air density to an electronic controller 72. The exhaust valves 26 are subsequently opened in the manner described herein to allow the cylinders 14A, 14B, 14C to exhaust through an exhaust passage 36 to an exhaust exit 38. The exhaust can be treated by a three-way catalyst 40, the performance of which is monitored by an upstream oxygen sensor 42A and a downstream oxygen sensor 42B which provide sensed parameters indicative of the performance of the catalyst 40 performance to the controller 72. The outlet valves 26 of the cylinders 16A, 16B, 16C are also opened according to the manner described herein to allow cylinders 16A, 16B, 16C to exhaust through a similar exhaust passage 36 to an exhaust exit 38. The exhaust from the cylinders 16A, 16B, 16C can be treated by another three-way catalyst 40, the performance of which is monitored by an upstream oxygen sensor 42A and a downstream oxygen sensor 42B. The sensors 42A, 42B are operatively connected to the controller 72, although connecting wires are not shown for simplicity in the drawings. Alternatively, the engine assembly 11 could be arranged so that exhaust from both banks 14, 16 of cylinders 14A, 14B, 14C, 16A, 16B, 16C can feed into a common exhaust passage.

Fuel is selectively introduced in the cylinders 14A, 14B, 14C, 16A, 16B, 16C via a fuel rail 82 and fuel injector 80 in a timed manner with firing of the spark plugs 28 to cause pistons 48 (shown in FIG. 2) within each of the cylinders 14A, 14B, 14C 16A, 16B, 16C to turn a crankshaft 50 supported by the cylinder block 12. The pistons 48 travel up and down within the cylinders 14A, 14B, 14C, 16A, 16B, 16C and cause rotation of the crankshaft 50 via connecting piston rods 52. A complete engine cycle (compression, ignition, combustion, exhaust) occurs over 720 degrees of rotation of the crankshaft 50. The crankshaft 50 supports a flywheel 54 (shown in FIG. 1) used to help maintain momentum and drive a transmission (not shown) operatively connected to the crankshaft 50. The flywheel 54 may be a dual-mass flywheel.

The engine assembly 11 is configured to balance the need to meet torque demands and operate with significant fuel efficiency and cost savings. Specifically, combustion within the cylinders 14A, 14B, and 14C of the first bank 14 is according to a fixed, predetermined engine operating efficiency. The inlet valves 24 of the first set of cylinders 14A, 14B, 14C are made to lift and lower by an overhead camshaft 60 shown in FIG. 2. Similarly, the outlet valves 26 of the first set of cylinders 14A, 14B, 14C are made to lift and lower by an exhaust camshaft 61. In FIG. 2, a camshaft cover is removed to expose the camshafts 60, 61. Furthermore, supporting bearings or mounts used to support the camshaft 60 over the cylinder head 18 are not shown for purposes of simplicity on the drawing. Such mounts could attach to the cylinder block 12 or the cylinder head 18, as will be readily understood by a person of ordinary skill in the art.

The camshafts 60, 61 have a variety of eccentric lobes 62A, 62B, 62C, 62D, 62E, 62F arranged to cause lifting and lowering of the valves 24, 26 of the cylinders 14A, 14B, 14C in a predetermined order and at a predetermined timing. The camshafts 60, 61 are driven by the crankshaft 50 through a belt drive 64 that can include a sprocket 66A mounted on the crankshaft 50, a sprocket 66B mounted on the camshaft 60, and a sprocket 66C mounted on the camshaft 61. A belt 68 connects the sprockets 66A, 66B, 66C. Belt tensioners and guides may be mounted to the cylinder block 12 but are not shown for purposes of simplicity in the drawing. In other embodiments, the belt drive 64 may be a gear train or a chain drive. Furthermore, two separate belts can be driven by the crankshaft 50 to drive the camshafts 60, 61 separately.

A camshaft phaser 70A can be operatively connected to the camshaft 60 and controlled by a controller 72 shown in FIG. 1 to vary the relative angular orientation of the camshaft 60 with respect to the crankshaft 50, thereby varying the timing of the opening and closing of the valves 24 with respect to the position of the respective pistons 48 within the cylinders 14A, 14B, 14C. Similarly, a camshaft phaser 70B can be operatively connected to the camshaft 61 and controller by the controller 72 to vary the relative angular orientation of the camshaft 61 with respect to the crankshaft 50, thereby varying the timing of the opening and closing of the valves 26. The phasers 70A, 70B can be hydraulic vane phasers, in which case the controller 72 ultimately controls the flow of hydraulic fluid to the phasers 70A, 70B to adjust the camshafts 60, 61. The hydraulic connection to the phasers 70A, 70B may be through passages within the cylinder block 12 and through the cylinder head 18 to the phaser 70A. 70B. These passages are not shown for purposes of simplicity in the drawings. A person of ordinary skill in the art would understand a variety of ways to route hydraulic fluid to the phasers 70A, 70B under the control of the controller 72. Any suitable phaser can be used.

Accordingly, combustion within the first bank 14 of cylinders 14A, 14B, 14C can be controlled to meet predetermined efficiency requirements. For example, the timing of the valves 24, 26 via the camshafts 60, 61 as well as the position of the throttle 32 can be controlled to allow combustion in the cylinders 14A, 14B, 14C so that the engine assembly 11 operates according to a predetermined combustion efficiency, such as may be indicated by a brake specific fuel consumption (BSFC) curve. Any or all of: (i) the timing of the opening of the valves 25, 27; (ii) the duration of the opening of the valves 25, 27; and (iii) the amount of lift of the valves 25, 27 can be implemented by the controller 72 to add displacement as needed to meet load demands. The load demands can be determined by the controller 72 based on a position sensor 74 connected to an accelerator pedal 76 above a vehicle floor 77. The position sensor 74 is operable to send a sensor signal to the controller 72. Load demands may further be determined by the controller 72 based on other sensed engine operating conditions, such as a speed sensor or a torque sensor operatively connected to the crankshaft 50. Inlet air parameters measured by the MAF sensor 29 can be used by the controller 72 in determining optimal valve timing and throttle position.

The controller 72 is operatively connected to the acoustic emission sensor 15 to receive the signal. The controller 72 has a processor 78 configured to execute stored instructions. In other words, the controller 72 is programmed to execute the stored instructions, by which the controller 72 carries out a method 200 represented in the flowchart of FIG. 2. Under the method 200, the acoustic emission sensor 15 can be used to monitor the engine operating parameters with respect to one or more engine components to determine whether the engine assembly 11 is operating according to predetermined operating parameters in order to meet predetermined efficiency or other requirements. More specifically, the sensed acoustic emissions can be compared to a predetermined and expected acoustic emissions signature as described herein to determine whether the engine assembly 11 is operating according to the predetermined operating parameters. If it is determined that the engine assembly 11 is not operating according to the predetermined operating parameters, the specific engine event occurring that is causing the acoustic emissions to differ from the expected, predetermined acoustic emissions can be identified, and the appropriate engine components and/or engine operating parameters can be adjusted so that the engine assembly 11 operates according to the predetermined operating parameters.

The acoustic emission sensor 15 can sense acoustic emissions at any portion of the engine assembly 11. Accordingly, the acoustic emission sensor 15 can be mounted anywhere on the engine assembly 11 and be used to detect any of one or more engine operating conditions that result in acoustic emissions, also referred to herein as engine events. Greater accuracy may be achieved by placing the acoustic emission sensor 15 close to the component or components involved with the specific engine event or events to be monitored. The acoustic emission sensor 15 is configured to provide a signal indicative of acoustic emissions in the engine assembly 11 as the engine assembly 11 is keyed on, cranked, runs over repeated engine cycles, and is keyed off.

In FIG. 1, the acoustic emission sensor 15 is shown mounted at position P1, on the inside of a cylinder 14B (i.e., on an inner surface of the cylinder 14B, within a cylinder bore of the cylinder 14B), such as to detect piston scuffing, piston ring fluttering, or an engine bearing failure, such as connecting rod bearing knock. Alternatively, the acoustic emission sensor 15 could be mounted at position P2 (at or near a fuel injector 80) to detect a start or an end of fuel injection, at position P3 (at or near the inlet valve 24), at position P4 (at or near the outlet valve 26) to detect a start or an end of engine valve actuation or valve train instability, at position P5 (at or near a cam phaser 70A) to detect actuation of a two-step cam or a shift of the cam phaser 70A, at position P6 to detect an air/fuel ratio imbalance or a misfire, at position P7 (at or near a fuel rail 82) to detect fuel rail dynamics, or at position P8 (at or near a flywheel, 54 such as a dual-mass flywheel) to detect a dual-mass flywheel event, such as a release of stored energy in the flywheel 54. The acoustic emission sensor 15 could be mounted in many other locations on the engine assembly and could be used to detect many other engine events not listed here. The acoustic emission sensor 15 is capable of detecting high frequency emissions, such as but not limited to emissions with frequency components greater than or equal to 30 kHz. Acoustic emissions in this high frequency range are distinct from acoustic emissions of normal cylinder resonance, which are in the 5 to 15 kHz range. Thus, acoustic emissions in this high frequency range may be indicative of an unexpected engine event. Such emissions can travel in metal at high speed and with little attenuation. Accordingly, a single emission sensor 15 located anywhere on or in a metal portion of the engine assembly 11 can be used to detect any of these events or any other engine event with a unique acoustic signature.

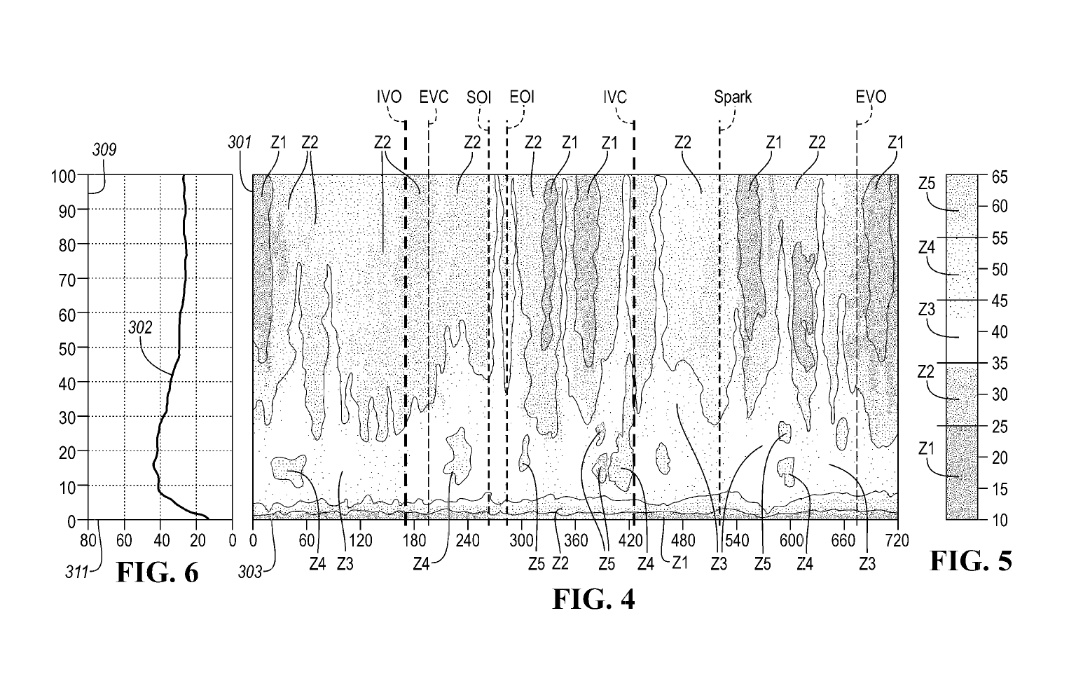

FIG. 4 shows a plot of the frequency (axis 301) of frequency components of the voltage signal from the acoustic sensor 15 (i.e., a sensor signal) for each crank angle over an engine cycle of 0 degrees to 720 degrees of rotation (axis 303) of the crankshaft 50 with the power spectral density of each frequency component indicated as being within a certain zone of power spectral density by shading. The sensor signal has been converted into frequency components by Fourier analysis in FIG. 4, and the value of each frequency component is indicated by its power density in dB/Hz, varying from 10 to 65, which is represented generally by various shaded zones Z1, Z2, Z3, Z4 and Z5, according to the chart of FIG. 5. Zone Z1 ranges from 0 to 25 dB/Hz. Zone Z2 ranges from more than 25 dB/Hz to 35 dB/Hz. Zone Z3 ranges from more than 35 dB/Hz to 45 dB/Hz. Zone Z4 ranges from more than 45 dB/Hz to 55 dB/Hz. Zone Z5 ranges from more than 55 dB/Hz to 65 dB/Hz. Those skilled in the art will readily understand the use of Fourier analysis to evaluate the relative powers of the frequency components of a signal.

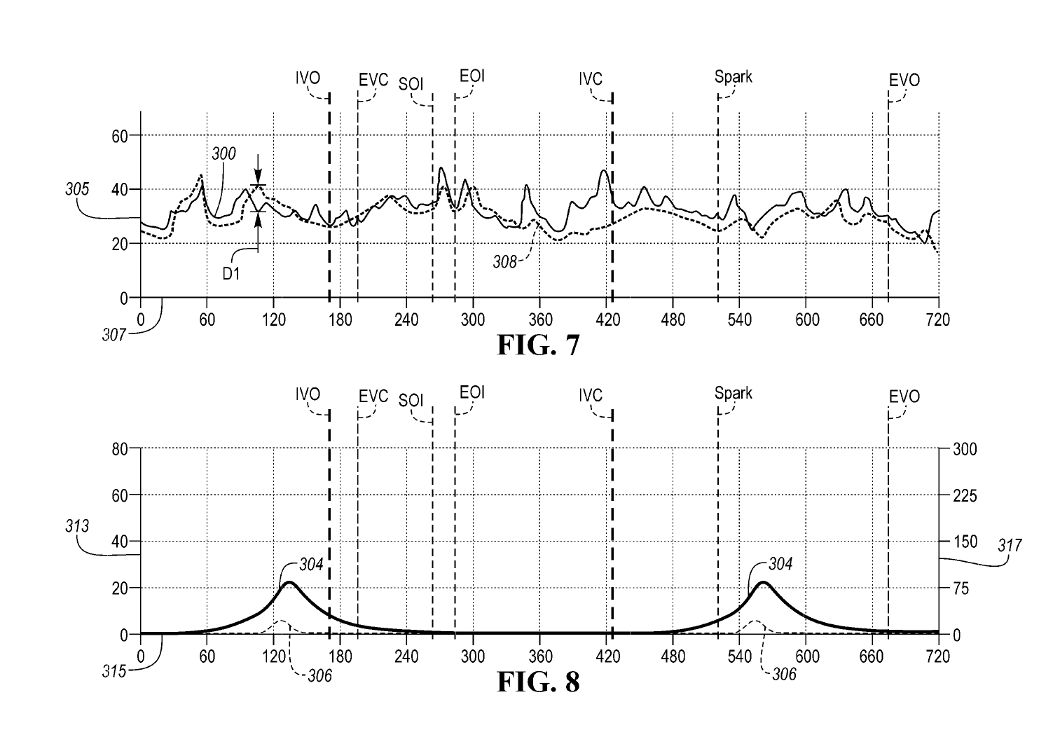

FIG. 7 shows a plot 300 of an average power spectral density (axis 305) in decibels per Hertz (dB/Hz) of the frequencies of the acoustic emissions of FIG. 4 at each crank angle from 0 degrees to 720 degrees (axis 307) of the crankshaft 50 during an engine cycle. The plot in FIG. 7 may be after a band pass filter is applied to the signal to eliminate frequencies above or below a selected band (i.e., range) of frequencies. A band pass filter may be applied when it is known that a specific engine event will affect acoustic emissions only within the selected range of frequencies. Frequencies outside of the range are irrelevant, and thus need not be analyzed, saving processing time of the processor 78.

FIG. 6 shows a plot 302 of frequency (axis 309) in KHz versus the average power spectral density (axis 311) in dB/Hz of the acoustic emissions of FIG. 4 at each frequency averaged over the entire engine cycle. The average power spectral density is a root mean square of the power of the various frequencies at each crank angle in FIG. 4 and may be referred to as a power value. FIG. 8 shows a plot 304 of cylinder pressure (axis 313) in bar in the cylinder 14B in which the acoustic emission sensor 15 is positioned in FIG. 1 versus crank angle from 0 degrees to 720 degrees (axis 315) of the crankshaft 50 during an engine cycle. Heat released in the cylinder 14B during the engine cycle (axis 317) in Joules per crank angle (J/CA) is shown as plot 306.

Some of the specific engine events occurring at specific crank angles during the engine cycle are indicated in each of FIGS. 4, 7 and 8. With respect to the cylinder 14B containing the acoustic emission sensor 15, opening of the inlet valves 24 occurs at line IVO, closing of the outlet valves 26 occurs at line EVC, start of ignition occurs at line SOI, end of ignition occurs at line EOI, closing of the inlet valves occurs at line IVC, spark within the cylinder 14B occurs at line SPARK, and opening of the outlet valves 26 occurs at line EVO.

Plot 300 is a baseline reference value of the power spectral density of the frequencies of the acoustic emissions of the engine assembly 11 when operating under predetermined, desired engine operating parameters. For example, the data shown in FIG. 4 may be taken when an engine assembly 11 is on a dynamometer, to establish plot 300 as a baseline reference value of power spectral density of FIG. 7. The plot 300 can be referred to as the baseline or reference acoustic emissions signature of the engine assembly 11 with the sensor 15 in the location shown in FIG. 1.

Plot 308 shown in FIG. 7 represents a power spectral density of the frequencies of the acoustic emissions of the engine assembly 11 (or an engine assembly 11 substantially identical to the engine assembly 11), as determined by the acoustic emission sensor 15 and the controller 72 at a different time than the baseline reference value power spectral density plot 300. The data establishing plot 308 may be taken during operation of the vehicle 10 on the road, or on a dynamometer for diagnostic testing, such as after a significant number of miles of operational use. For example, acoustic emission frequencies having the power spectral density of plot 308 may be determined while the vehicle 10 is being operated by a driver during onboard monitoring and diagnostics (i.e., real time diagnostics), or during diagnostic testing while the engine assembly 11 is being serviced. By the controller 72 comparing a difference between the baseline acoustic emissions of the power spectral density of plot 300 and the acoustic emissions of the power spectral density of plot 308, operation of the engine assembly 11 is monitored and diagnosed, and the controller 72 can then adjust the engine assembly 11 to the desired operating parameters.

Moreover, the specific engine event that causes a difference in power value from the baseline reference power value of plot 300 at a specific crank angle can be determined by the controller 72. This can be accomplished by first creating a stored database of power spectral densities of the acoustic emissions of the engine assembly 11 when the engine assembly 11 is purposefully controlled or adjusted to create various engine events. The acoustic emission signatures of each of these events, as indicated by the specific power spectral densities of the frequencies of the acoustic emissions over the engine cycle, can be used to identify the variations from the reference power value over the engine cycle. Using this information, the operating parameters of the appropriate engine component of the engine assembly 11 can be adjusted to reduce the difference between the actual acoustic emissions (plot 308) and the expected acoustic emissions as indicated by the baseline reference power spectral density plot 300. The acoustic emissions indicated by the sensor 15 are thus used by the controller 72 to diagnose engine events, so that the controller 72 can adjust engine operation, such as by adjusting the settings or positioning of the appropriate engine components, and/or the engine components can be repaired if necessary.

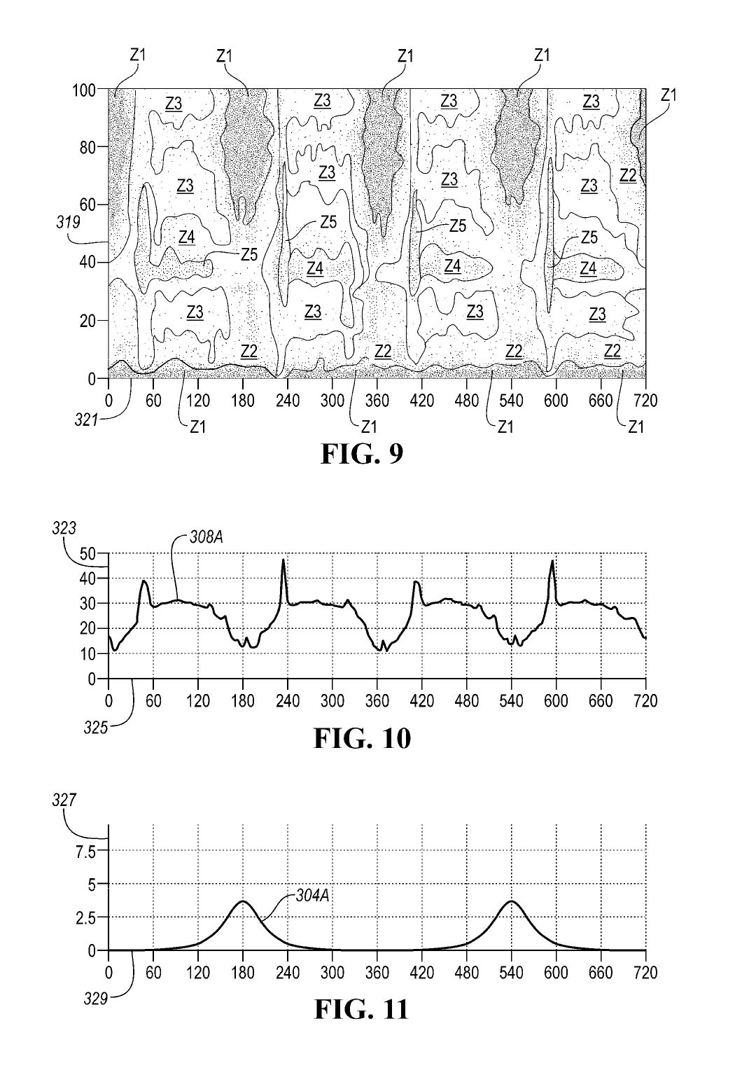

FIGS. 9-14 relate to a signal received from the acoustic emission sensor 15 at a different time under different operating conditions during operation of the engine assembly 11 than during establishment of the baseline plot 300 or during establishment of the plot 308 of FIG. 4. FIG. 9 shows a plot of the frequency (axis 319) of frequency components of the voltage signal from the acoustic sensor 15 (i.e., a sensor signal) for each crank angle over an engine cycle of 0 degrees to 720 degrees of rotation (axis 321) of the crankshaft 50 with the power spectral density of each frequency component indicated as being within a certain zone of power spectral density by shading corresponding with the zones Z1-Z5 of FIG. 5. For example, the plot 308A in FIG. 10 is the average power spectral density (axis 323) in dB/Hz of the frequencies of the acoustic emissions data of FIG. 9 at each crank angle over an engine cycle of 0 degrees to 720 degrees of rotation (axis 325) of the crankshaft 50. FIG. 11 shows plot 304A of the in-cylinder pressure (axis 327) in bar taken at each crank angle over an engine cycle of 0 degrees to 720 degrees of rotation (axis 329) of the crankshaft 50. FIG. 12 shows that a plot 302A of frequency (axis 331) in KHz versus the average power spectral density (axis 333) in dB/Hz of the acoustic emissions of FIG. 9 at each frequency averaged over the entire engine cycle is different than the plot 302 of FIG. 6 established as the baseline reference.

By analyzing the signal of the acoustic emission sensor 15, it can be determined that a specific engine event affects acoustic emissions at a specific range of crank angles of the engine cycle and in a specific range of frequencies. The occurrence of the engine event can thus be diagnosed and monitored by the controller 72 analyzing the frequencies of the sensor signal associated with that specific range of crank angles. Emissions data falling outside of the specific range of crank angles and having frequencies outside of the specific range of frequencies can be considered irrelevant to the occurrence of the specific engine event and need not be analyzed. Accordingly, the processor time required of the controller 72 is thus minimized.

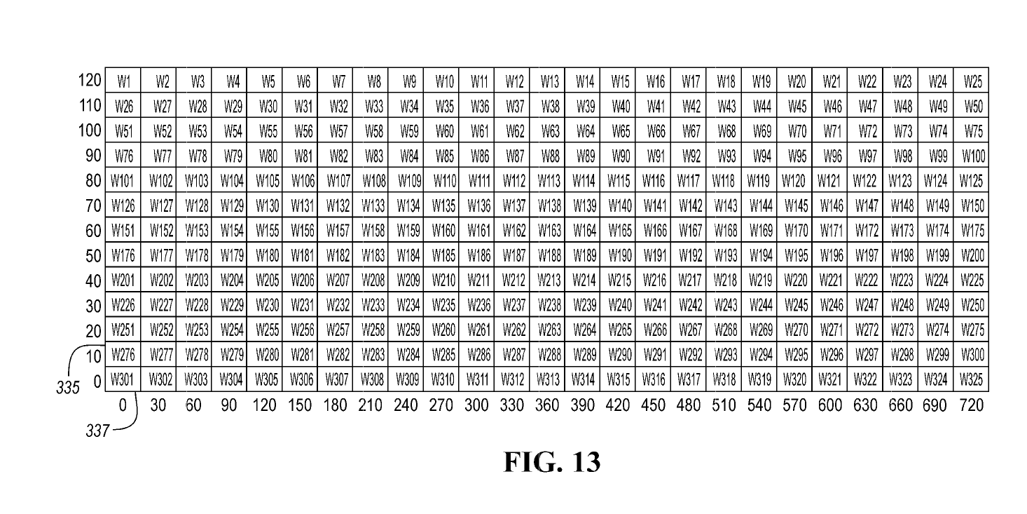

FIG. 13 shows one example of such discretization of the emissions data where domains of the frequency (axis 335) and crank angle over an engine cycle of 0 degrees to 720 degrees of rotation (axis 337) of the crankshaft 50 are divided into discrete regions numbered from 1 to 325. The regions are also referred to as windows. In the embodiment shown, each window is 10 kHz by 30 degrees. In other words, the engine cycle is divided into crank angle ranges in 30 degree increments from 0 degrees to 720 degrees, and the frequency data of the sensor signal is divided into 10 KHz increments.

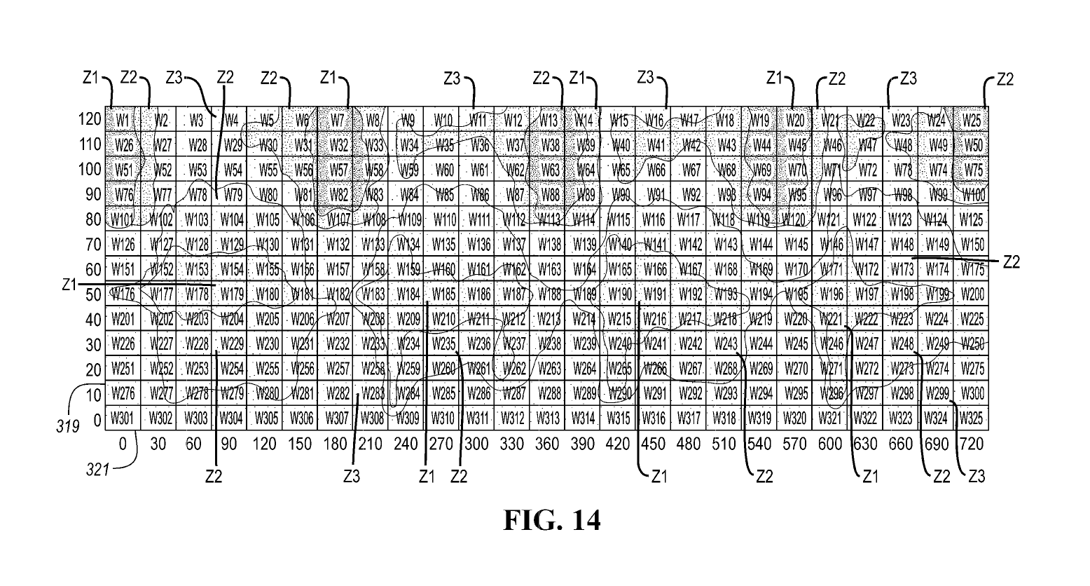

FIG. 14 shows the grid of the windows of FIG. 13 overlaid on the acoustic emission sensor data of FIG. 9. The ranges of increments are for purposes of example only, and different ranges may be selected within the scope of the present teachings. A discrete window or set of windows can be analyzed for a given engine event. For purpose of example only, the sensor data associated with the range of engine crank angles and the range of frequencies of windows W203, W204, W228, and W229 can be analyzed for a first specific engine event, while the sensor data associated with the range of engine crank angles and the range of frequencies windows W116, W117, and W118 can be analyzed for a second different specific engine event, and the sensor data associated with windows W13, W38, W63, W88, W113, W138, W163, W188, W213, W238, W263, W288, and W313 can be analyzed for a third different specific engine event. Data in all other windows is not analyzed. In general, selecting a greater range of crank angles and/or frequencies may more accurately indicate the occurrence of a specific engine event, but will require greater processing time. One or more windows can be analyzed in relation to one or more specific engine events. Data in the other windows need not be analyzed, thus saving on processing capability.

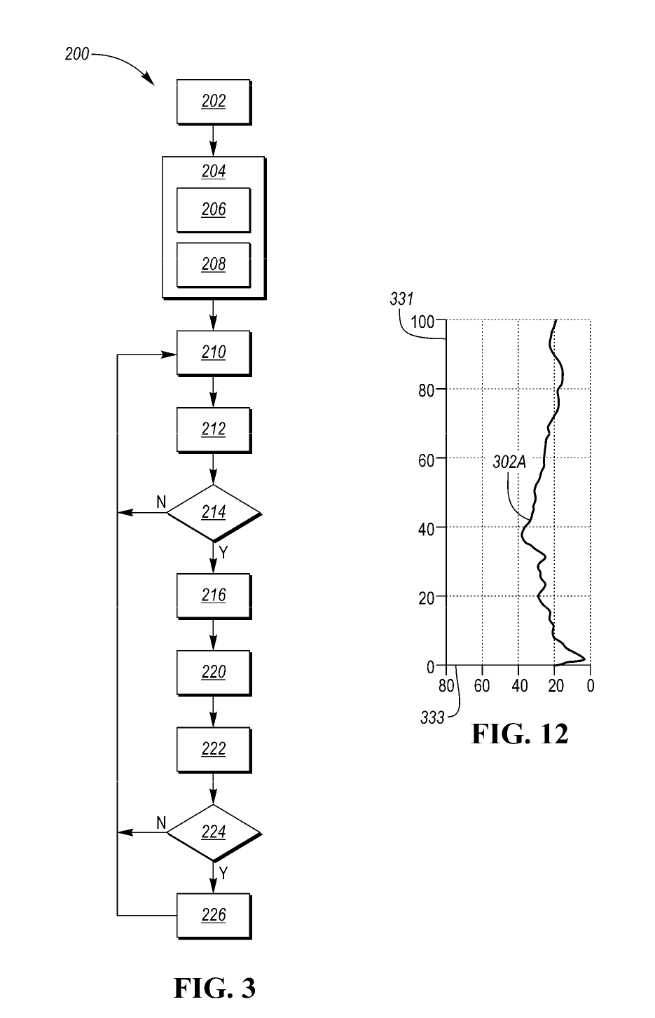

With reference to FIG. 3, the method 200 of determining engine events may begin with block 202, establishing a baseline reference value of the power of the frequency components of an acoustic emission sensor signal as a function of crank angle for an engine assembly 11 operating according to predetermined operating parameters. For example, the baseline reference value is an indication of expected acoustic emissions as detected by the acoustic sensor, when the engine assembly 11 is operating according to predetermined, desired parameters considered normal or optimal. The baseline reference value may be established with the engine assembly 11 running on a dynamometer or during a road test. The baseline reference value may vary with engine crank angle over an engine cycle. The baseline reference power value may be a power spectral density per unit of frequency of the sensor signal. If the signal data represented in FIG. 4 is under the optimal operating parameters, then the plot 300 is thus the baseline reference value of the power spectral density. If the controller 72 is provided in which the baseline reference power value has already been determined and stored in a database, then the method 200 need not include block 202.

Optionally, the method 200 may include block 204, identifying windows of different ranges of frequencies and different ranges of crank angles to be analyzed. For example, this may include creating the discretization grid of FIG. 13. Block 204 may further include correlating different specific engine events with different windows or groups of windows. For example, block 206 may include correlating a first specific engine event with one or more of the windows. Testing may determine that a first specific engine event, such as actuation of a cam phaser 70A, affects acoustic emissions, as indicated by the power spectral density, in one or more of the windows. Block 208 may include correlating a second specific engine event with a different one or ones of the windows. For example, testing may determine that inlet valve opening affects the acoustic emissions as indicated by power spectral density at other specific windows. Accordingly, blocks 202-208 involve creating the stored data base of information to be referenced by the processor 78 in carrying out the stored algorithm.

In block 210, the controller 72 receives the sensor signal from the acoustic emission sensor 15. Next, if optional blocks 204-208 have been performed, then in block 212 the controller 72 will identify a portion of the signal associated with a predetermined range of crank angles characteristic of the occurrence of the first specific engine event, as correlated in block 206. In block 214, the controller 72 will convert the portion of the signal into its frequency components, and determine whether any of the frequency components of the portion of the signal identified in block 212 is within the first predetermined range of frequencies. If none of the frequency components are within the first predetermined range of frequencies, then the method returns to block 210. If any of the frequency components of the portion of the signal are within the first predetermined range of frequencies, then the first engine event is likely to have occurred. Portions of the signal not within the one or more windows identified in block 206 need not be analyzed, thus reducing processing time. If optional blocks 204-208 are not included in the method 200, then the entire signal is converted into its frequency components over the entire range of engine crank angles in block 216.

In block 220, the frequency components of the sensor signal identified in block 216 may be filtered through a band pass filter to focus on only a selected bandwidth of the frequencies. The frequencies inside of the band pass filter range are those that have been correlated with the specific engine event or events to be identified.

Next, in block 222, the respective power value of the one or more frequency components within the band pass filter range is then determined. For example, a root mean square power of the filtered frequency components is determined, such as is shown in the power spectral plot 308. More specifically, Fourier analysis is used to identifying frequency components of the signal in block 216 and determine the power values of the different frequency components in block 222. Those skilled in the art will readily understand Fourier analysis. The power value determined in block 222 may be limited to one or more portions of the signal correlated with predetermined ranges of engine crank angles and which are characteristic of the occurrence of specific engine events, as described with respect to the discretization pf the data shown in FIGS. 13 and 14.

In block 224, the power value is then compared to the reference value associated with the baseline engine cycle to determine if the difference is greater than a predetermined difference. With reference to FIG. 7, for example, the plot 300 is the reference power value, and the plot 308 is the power value of the filtered frequency components of block 222. The difference between the power value determined in block 222 and the reference value determined in block 202 is determined. For example, at an engine crank angle of about 100 degrees, the difference is the distance D1 along the Y-axis between the plots 300 and 308 in FIG. 7. The difference is compared to a predetermined threshold difference. If the difference is greater than the predetermined threshold difference, the method 200 then moves to block 226 and adjusts an operating parameter of an engine component that affects the engine event. For example, the controller 72 provides a control signal to adjust one or more of the engine components, such as the inlet valves 24, the outlet valves 26, the cam phaser 70A, the fuel injectors 80, the throttle 32, etc., depending on the specific engine event.

If the difference is less than or equal to the predetermined threshold difference, then the signal of the acoustic emission sensor 15 indicates that the monitored engine assembly is operating within acceptable operating parameters. The method 200 then returns to block 210 to analyze the subsequent time step of the signal (i.e., the signal associated with the next engine crank angle or range of engine crank angles, and the method 200 proceeds through blocks 212 to 226 for each window of the signal identified in blocks 204-208, or continuously if discretization is not employed.

Thus, by utilizing an acoustic emission sensor and analyzing the signal from the sensor is as disclosed herein, the engine assembly 11 can be monitored and controlled to operate according to preferred, predetermined operating parameters. The monitoring and controlling can occur during operation of the vehicle 10 while it is being driven (onboard diagnostics), and/or can occur during diagnostic testing of the engine assembly 11 in a lab or repair setting. A single acoustic sensor 15 can be used to determine many different engine events. The sensor may be positioned in any one of many different locations P1, P2, P3, P4, P5, P6, etc., including a location on an outer surface of the engine assembly 11 that is easy to access and is not typically subjected to a harsh environment.

While the best modes for carrying out the many aspects of the present teachings have been described in detail, those familiar with the art to which these teachings relate will recognize various alternative aspects for practicing the present teachings that are within the scope of the appended claims.

1. A system for detecting engine events comprising:
an engine assembly;
an acoustic emission sensor mounted on the engine assembly and configured to provide a signal indicative of acoustic emissions in the engine assembly during an engine cycle;
a controller operatively connected to the acoustic emission sensor to receive the signal; wherein the controller has a processor configured to execute stored instructions, and is programmed to:
convert the signal into one or more frequency components;
filter the signal with a band pass filter to eliminate any of the frequency components outside of a range of frequencies of the band pass filter;
determine a power value of each of the one or more frequency components within the range of frequencies of the band pass filter;
compare the power value of each of the one or more frequency components to a reference value associated with acoustic emissions in the engine assembly during a baseline engine cycle; and
adjust at least one operating parameter of the engine assembly if the power value differs from the reference value by at least a predetermined amount.

2. The system of claim 1, wherein the controller is further programmed to:
identify a portion of the signal correlated with a predetermined range of engine crank angles and characteristic of an occurrence of a specific engine event;
determine whether any of the one or more frequency components of the portion of the signal are within a predetermined range of frequencies; and
wherein the power value is determined only with respect to the portion of the signal and the one or more frequency components of the portion of the signal that are within the predetermined range of frequencies.

3. The system of claim 2, wherein the controller is further programmed to:
prior to converting the signal into one or more frequency components, correlate the occurrence of the specific engine event with frequency components within the predetermined range of crank angles and the predetermined range of frequencies.

4. The system of claim 2, wherein the portion of the signal is a first portion of the signal, the predetermined range of engine crank angles is a first predetermined range of crank angles, and the specific engine event is a first specific engine event; and wherein the controller is further programmed to:
identify a second portion of the signal correlated with a second predetermined range of engine crank angles;
determine whether any of the one or more frequency components of the second portion of the signal are within a second predetermined range of frequencies; and
wherein the power value is determined only with respect to the second portion of the signal and the one or more frequency components of the second portion of the signal that are within the second predetermined frequency range of frequencies; and
wherein frequency components of the signal within the second predetermined range of frequencies and occurring within the second predetermined range of engine crank angles is characteristic of an occurrence of a second specific engine event.

5. The system of claim 4, wherein the second predetermined range of frequencies is different than the first predetermined range of frequencies.

6. The system of claim 1, wherein the engine assembly includes a cylinder block with cylinder bores, and the acoustic emission sensor is mounted to a portion of the engine assembly outside of the cylinder bores.

7. The system of claim 6, wherein the portion of the engine assembly is one of an outer surface of the cylinder block, a surface of a cam cover, a cylinder head, or a bell housing of a dual-mass flywheel.

8. The system of claim 6, wherein the specific engine event is one of a start or an end of fuel injection, a start or an end of engine valve actuation, actuation of a two-step cam, valve train instability, piston scuffing, piston ring fluttering, an engine bearing failure, an air/fuel ratio imbalance, a misfire, fuel rail dynamics, a shift of a cam phaser, or a dual mass flywheel event.

9. The system of claim 1, wherein the signal is indicative of acoustic emissions emanating from different portions of the engine assembly; wherein the controller is further programmed to:
prior to converting the signal into one or more frequency components, identify windows of different ranges of frequencies and different ranges of engine crank angles in which the signal is characteristic of different specific engine events; and
wherein the power value is determined only with respect to the one or more frequency components of portions of the signal within said windows.

10. The system of claim 1, wherein the signal provided by the acoustic emission sensor is configured to detect a range of frequencies including frequencies greater than 30 kilohertz.

11. The system of claim 1, wherein the engine assembly is installed on a vehicle; and wherein the controller adjusts the at least one of the operating parameters of the engine assembly in real time during engine operation while the vehicle is being driven.

12. The system of claim 1, wherein the controller adjusts the at least one of the operating parameters of the engine assembly during diagnostic testing of the engine assembly.

13. A system for detecting engine events comprising:
an engine assembly;
an acoustic emission sensor mounted on the engine assembly and configured to provide a signal indicative of acoustic emissions in the engine assembly during an engine cycle;
a controller operatively connected to the acoustic emission sensor to receive the signal; wherein the controller has a processor configured to execute stored instructions, and is programmed to:
convert only selected portions of the signal into one or more frequency components; wherein the selected portions of the signal are at different specific ranges of engine crank angles;
filter the signal with a band pass filter;
determine a respective power value of any of the one or more frequency components of the selected portions of the signal that are within different specific ranges of frequencies; wherein the selected portions of the signal in the different specific range of engine crank angles and the different specific ranges of frequencies are characteristic of different specific engine events;
compare the respective power value to a respective reference value associated with acoustic emissions in the engine assembly during a baseline engine cycle; and
adjust at least one operating parameter of the engine assembly if a difference between the respective power value and the respective reference value is greater than a predetermined difference.

14. The system of claim 13, wherein the signal is indicative of acoustic emissions emanating from different portions of the engine assembly; and wherein each different specific engine event is associated with a different one of said different portions of the engine assembly.

15. The system of claim 13, wherein the different specific engine events include one of a start or an end of fuel injection, a start or an end of engine valve actuation, actuation of a two-step cam, valve train instability, piston scuffing, piston ring fluttering, an engine bearing failure, an air/fuel ratio imbalance, a misfire, fuel rail dynamics, a shift of a cam phaser, or a dual mass flywheel event.

16. The system of claim 13, wherein the engine assembly is installed on a vehicle; and wherein the controller adjusts the at least one of the operating parameters of the engine assembly in real time during engine operation while the vehicle is being driven.

17. The system of claim 13, wherein the controller adjusts the at least one of the operating parameters of the engine assembly during diagnostic testing of the engine assembly.

18. A method for detecting engine events comprising:
converting a signal indicative of acoustic emissions in an engine assembly during an engine cycle into one or more frequency components; wherein the signal is provided by an acoustic sensor mounted on the engine assembly;
filtering the signal with a band pass filter to eliminate any of the one or more frequency components outside of a range of frequencies of the band pass filter;
determining a power value of each of the one or more frequency components within the range of frequencies of the band pass filter;
comparing the power value of each of the one or more frequency components to a respective reference value associated with acoustic emissions in the engine assembly during a baseline engine cycle; and
adjusting at least one operating parameter of the engine assembly if a difference between the power value and the reference value is greater than a predetermined threshold difference.

19. The method of claim 18, wherein said converting comprises converting only selected portions of the signal into one or more frequency components; wherein the selected portions of the signal are in different specific ranges of engine crank angles and different specific ranges of frequencies and are each characteristic of an occurrence of a different specific engine event.
